(19) United States
(12) Patent Application Publication
(10) Pub. No.: US 2022/0372300 A1
(43) Pub. Date: Nov. 24, 2022

(54) PIGMENT AND INK FOR ELECTROPHORETIC DISPLAY USING BLACK TITANIUM DIOXIDE

(71) Applicant: FOUNDATION FOR RESEARCH AND BUSINESS, SEOUL NATIONAL UNIVERSITY OF SCIENCE AND TECHNOLOGY, Seoul (KR)

(72) Inventors: Youngin LEE, Gwangmyeong-si, Gyeonggi-do (KR); Myeongjun JI, Seoul (KR); Eungryong KIM, Seoul (KR); Jeonghyun KIM, Seoul (KR)

(21) Appl. No.: 17/762,045

(22) PCT Filed: Nov. 6, 2019
(86) PCT No.: PCT/KR2019/014985

§ 371 Date: Mar. 18, 2022

(30) Foreign Application Priority Data
Sep. 24, 2019 (KR) 10-2019-0117522

(51) Int. Cl. C09C 1/36; C01G 23/04; C09C 3/08; C09D 11/037; C09D 11/52; G02F 1/1675

(52) U.S. Cl. CPC C09C 1/3669; C01G 23/043; C09C 3/08; C09D 11/037; C09D 11/52; G02F 1/1675; C01P 2004/64; C01P 2004/62; C01P 2006/40; C01P 2002/72; C01P 2002/82; C01P 2004/04; G02F 2001/1678

(57) ABSTRACT

The present invention relates to a pigment for a black electrophoretic display having high electrical insulation and excellent dispersibility in the visible region. An objective of the present invention is to provide black titanium dioxide as a pigment for an electrophoretic display. In addition, another objective of the present invention is to provide an ink composition for an electrophoretic display comprising a black titanium dioxide pigment, and an electrophoretic display.

### TECHNICAL FIELD

The present disclosure relates to a pigment for a black electrophoretic display having high electrical insulation and excellent dispersibility in the visible region.

### BACKGROUND ART

Electrophoretic displays (EPDs) are non-emissive devices based on electrophoretic phenomena affecting charged pigment particles dispersed in a dielectric solvent. EPDs usually include a pair of plate-shaped electrodes spaced apart. At least one of the electrode plates is transparent, typically the one on the viewing side. Electrophoresis fluid is composed of a dielectric solvent in which charged pigment particles are dispersed interposed between the two electrode plates.

Pigment particles used in electrophoretic displays are generally white titania and black carbon-black particles. The reason for using carbon-black as a black pigment is that a large amount of carbon-black is easily available, and the price is low.

However, carbon-black pigments are inherently conductive materials, and short-circuits may easily occur, and there is a problem in that sufficient insulation is not exhibited even when coated with a resin. In addition, carbon-black has an inherent problem of inducing strong aggregation between particles being difficult to apply a dispersant.

In recent years, carbon-black particles have been double-coated to sufficiently exhibit insulation and hydrophobicity in order to solve the above problems. However, in the case of double coating, there is a problem in that the size of the particles increases and sedimentation easily occur and dispersibility and fluidity deteriorate. In addition, when a hydroxyl group or a carboxyl group is introduced through a pretreatment process using an acid solution to coat a hydrophobic silane group or the like on a hydrophilic surface of the carbon-black particles, a defect may occur on a pigment surface, and a plurality of acid waste solutions may be generated. Therefore, a black particle dispersion for an electrophoresis display that does not have problems with the carbon black above, for example, which facilitates low electrical conductivity and surface modification, is required. However, finding such black particles is quite difficult, and black pigments in similar fields are known. However, it is also difficult to find particles with appropriate physical properties for use in electrophoresis displays.

### RELATED ART LITERATURE

### Patent Literature

(Patent literature 1) Korean Patent Application Publication No. 10-2017-0111920 (published date: 2017.10.12)
(Patent literature 2) Korean Patent Application Publication No. 10-2018-0115664 (published date: 2018.10.23)

### DISCLOSURE

### Technical Problem

An objective of the present disclosure is to provide black titanium dioxide as pigment for an electrophoretic display.

Another objective of the present disclosure is to provide an electrophoretic display ink including black titanium dioxide pigment and an electrophoretic display using the same.

### Technical Solution

The present disclosure provides a pigment for an electrophoretic display, the pigment including inorganic oxide.

The inorganic oxide may be black titanium dioxide.

The black titanium dioxide may have a crystal phase selected from the group consisting of anatase phase, rutile phase, and mixtures thereof.

The pigment may have inorganic oxide as a core part and a shell part surrounding the surface of the core part.

The shell part may be hydrophobic.

The shell part may include any one among one or more hydrocarbons, phosphoric acid, and a combination thereof.

The pigment may have a particle diameter of 5 nm to 200 nm.

The pigment may exhibit 14% or less of reflectance for visible light.

Provided is an ink composition for an electrophoretic display, the ink composition including any one selected from the above-mentioned pigments, a dielectric medium in which the pigment particles are dispersed, and an additive for enhancing the dispersion characteristics of the pigment.

The dielectric medium may have a dielectric constant of 2 to 10 F/m.

Provided is an electrophoretic display including any one of the above-described ink compositions.

### Advantageous Effects

According to the present disclosure, it is possible to prevent a short-circuit phenomenon by using black titanium dioxide, which is an insulating material, as a pigment.

According to the present disclosure, it is possible to improve the dispersibility of a pigment through an eco-friendly and simple surface modification process, by using black titanium dioxide, which can be easily surface-modified, as the pigment.

### DESCRIPTION OF DRAWINGS

FIG. 1 is a photograph of gray and black titanium dioxide (TiO₂-x) powder;

FIG. 2 is a view showing a result of X-ray diffraction analysis of a synthesized TiO₂₋ₓ powder;

FIG. 3 is a view showing a result of Raman analysis of a synthesized TiO₂₋ₓ powder and the commercial TiO₂₋ₓ powder;

FIG. 4 is a view showing an FT-IR analysis result of the black titanium dioxide powder prepared in Example 1;

FIG. 5 is a view showing a reflectance analysis result of gray and black TiO₂₋ₓ nanoparticles;

FIG. 6 is a transmission electron microscope photograph of TiO₂₋ₓ powder according to an embodiment of the present disclosure;

FIG. 7 is a photograph of ink including a synthesized TiO₂₋ₓ powder and a solvent according to an embodiment of the present disclosure;

FIGS. 8(a), 8(b), and 8(c) are graphs showing the results of particle size analysis of the ink including the synthesized TiO₂₋ₓ powder and the solvent, respectively, according to an embodiment of the present disclosure;

FIGS. 9(a) and 9(b) are graphs showing dispersion evaluation results according to an Example and a Comparative Example of the present disclosure, respectively; and

FIGS. 10(a), 10(b), and 10(c) are evaluations of the driving speed of the electrophoretic display according to the average particle size of the ink according to an embodiment of the present disclosure, respectively.

### BEST MODE

Advantages and features of the present disclosure, and methods for achieving them, will become apparent with reference to the embodiments described below in detail in conjunction with the accompanying drawings. However, the present disclosure is not limited to the embodiments disclosed below but may be implemented in various different forms. The present embodiment is provided to complete the disclosure of the present disclosure and to completely inform the scope of the present disclosure to those skilled in the art, and the present disclosure is only defined by the scope of the claims. Like reference numerals refer to like elements throughout.

The terminology used herein is for the purpose of describing the embodiments and is not intended to limit the present disclosure. In this specification, the singular also includes the plural unless specifically stated otherwise in the phrase. As used herein, ‘comprises’ and/or ‘comprising’ does not preclude the presence or addition of one or more other elements, steps, operations, and/or devices mentioned.

The present disclosure provides pigment for an electrophoretic display, the pigment including inorganic oxide.

The inorganic oxide may include any one of silicon (Si), titanium (Ti), barium (Ba), strontium (Sr), iron (Fe), nickel (Ni), cobalt (Co), lead (Pb), aluminum (Al), copper (Cu), silver (Ag), gold (Au), tungsten (W), molybdenum (Mo), zinc (Zn), and zirconium (Zr), or a combination of one or more thereof. Preferably, the inorganic oxide may be black titanium dioxide.

The black titanium dioxide may have a crystal phase selected from the group consisting of anatase phase, rutile phase, and mixtures thereof.

The pigment may have inorganic oxide as a core part and a shell part surrounding a surface of the core part. The shell part may be hydrophobic.

The shell part may include any one among one or more hydrocarbon, phosphoric acid, and a combination thereof.

The pigment may have a particle diameter of 5 nm to 200 nm. The smaller the pigment particle size, the faster the driving speed in the electrophoretic display.

The visible light reflectance of the pigment may be 14% or less.

Provided is an ink composition for an electrophoretic display, including any one selected from the above-mentioned pigments, a dielectric medium in which the pigment particles are dispersed, and an additive for enhancing the dispersion characteristics of the pigment.

The dielectric medium may have a dielectric constant of 2 to 10 F/m.

Hereinafter, the present disclosure will be described in more detail through examples. These examples are only for illustrating the present disclosure, and it will be apparent to those of ordinary skilled in the art that the scope of the present disclosure is not to be construed as being limited by these examples.

### Example 1—Method for Preparing Black Titanium Dioxide (TiO₂₋ₓ) Powder

0.1M titanium isopropoxide ethylene glycol solution 100 ml and 0.2M citric acid 200 ml were mixed and heated and stirred at 100° C. for 1 hour. Black titanium dioxide (TiO₂₋ₓ) nanoparticles with a shell part including a hydrocarbon group were synthesized. After cooling the reaction mixture to room temperature, the reaction mixture was washed with ethanol three times using a centrifuge and dried at 60° C. to prepare black titanium dioxide (TiO₂₋ₓ) nanoparticle powder. FIG. 1 (left) shows a photograph of the prepared powder.

### Comparative Example 1—Method for Preparing Gray Titanium Dioxide (TiO₂₋ₓ) Powder

Gray titanium dioxide powder was prepared in the same manner as in Example 1, except that the reaction temperature was set to 90° C. in Example 1. FIG. 1 (right) shows a photograph of the prepared powder.

### Example 2—Preparation of Ink Containing Black Titanium Dioxide (TiO₂₋ₓ) Powder and Solvent

Each of the black titanium dioxide nanoparticles prepared in Example 1 15 g, Isopar L 20 g, HaloCarbon oil 0.8 10 g, DISPERBYL-116 10 g, methyl isobutyl ketone (MIBK) 80 g, and 50 g of zirconia balls (500 μm) were added and dispersed for 14 days using a ball-mill disperser. Thereafter, zirconia balls and foreign substances were removed using a PP filter (300 mesh) to prepare a nanoparticle dispersion.

### Examples 3 and 4—Particle Size Control of Black Titanium Dioxide (TiO₂₋ₓ) Powder

Black titanium dioxide powder was prepared in the same manner as in Example 1, except that citric acid was set to 50 ml and 100 ml, respectively, in Example 1. Examples 3 and 4 dispersions were prepared in the same manner as in Example 2 using each of the powders prepared by the above method.

### Comparative Example 2—Preparation of Ink Containing Carbon-Black Powder and Solvent

In order to prepare ink using carbon-black, several surface treatment processes are basically required. To shorten the surface treatment process experimentally, Monarch 1400 product produced by CABOT Co., whose surface was treated with nitric acid, was used. The carbon-black above 5 g, 1 L of hexane, and 100 g of oleic acid were stirred at 500 rpm for 24 hours in an atmosphere of 60° C. for 24 hours. After recovering the carbon-black particles using a centrifuge, the process of redispersing the carbon-black particles again in the same ratio of hexane and oleic acid solutions as above and recovering the particles using a centrifuge again was repeated 4 more times. 3 g of the carbon-black particles which the surface treatment has been completed, 65 g of Isopar L, 22 g of HaloCarbon oil 0.8, 10 g of TEGO-Dispers 760W, and 50 g of zirconia balls (500 μm) were added thereto and dispersed at 1500 rpm for 15 hours using a horizontal disk-mill disperser. Thereafter, zirconia balls and foreign substances were removed using a PP filter (300 mesh) to prepare a carbon-black particle dispersion.

### Example 5—Black Titanium Dioxide (TiO₂₋ₓ) Based Electrophoretic Display Fabrication

A display for confirming the electrophoretic properties of the ink containing black titanium dioxide (TiO₂₋ₓ) powder and a solvent in Example 2 was manufactured. As the lower electrode, ITO Glass was patterned to form a plurality of line-shaped patterns with an ITO line width of 30 um and an interval between ITO patterns of 70 um. In addition, as the upper electrode, general ITO glass was used without a pattern. Parts of the edge were attached to maintain the gap with a double-sided tape having a thickness of 20 μm, and the ink prepared in Example 2 was injected into a gap between ITO glass plates for upper and lower electrodes using a dropper and then sealed.

### Experimental Example 1—XRD Analysis

The black titanium dioxide (TiO₂₋ₓ) nanoparticles prepared by the preparation method of Example 1 were analyzed by X-ray diffraction (XRD). As a result of the analysis, it was confirmed that only the TiO₂ crystal peak appeared.

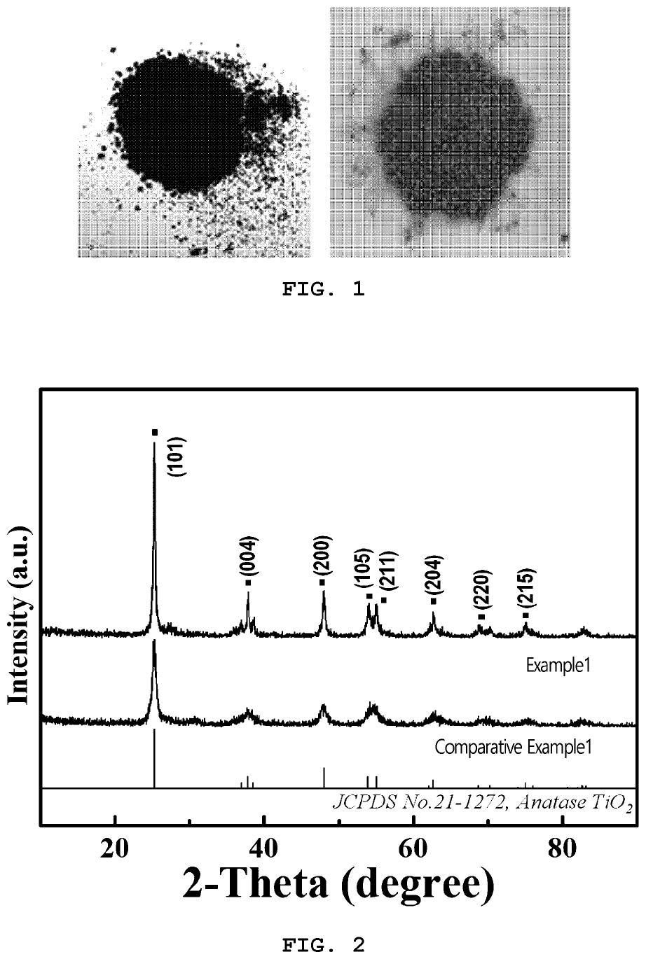

As a result of X-ray diffraction (XRD) analysis of the gray titanium dioxide (TiO₂₋ₓ) nanoparticles prepared by the manufacturing method of Comparative Example 1, it was confirmed that only the TiO₂ crystal peak appeared (FIG. 2).

### Experimental Example 2—Raman Analysis

Through Raman comparison analysis with the commercial white titanium dioxide powder and the powder prepared in Example 1, it was confirmed that the prepared powder through the fact that the peak at about 200 cm⁻¹ was observed and the peak at 300 cm⁻¹ or less became gentle was TiO₂₋ₓ with oxygen pores.

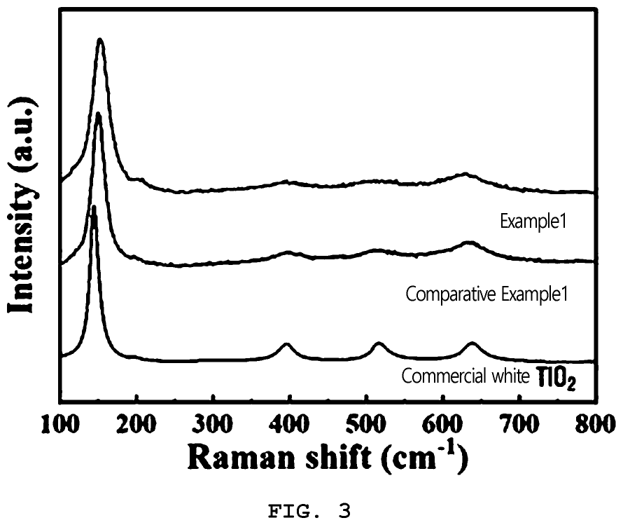

Through Raman comparative analysis with commercial white titanium dioxide powder and the powder prepared in the preparation method of Comparative Example 1, it was confirmed that the prepared powder through the fact that the peak at about 200 cm⁻¹ was observed and a peak of 300 cm⁻¹ or less became gentle was TiO₂₋ₓ with oxygen pores (FIG. 3).

### Experimental Example 3—FT-IR Analysis

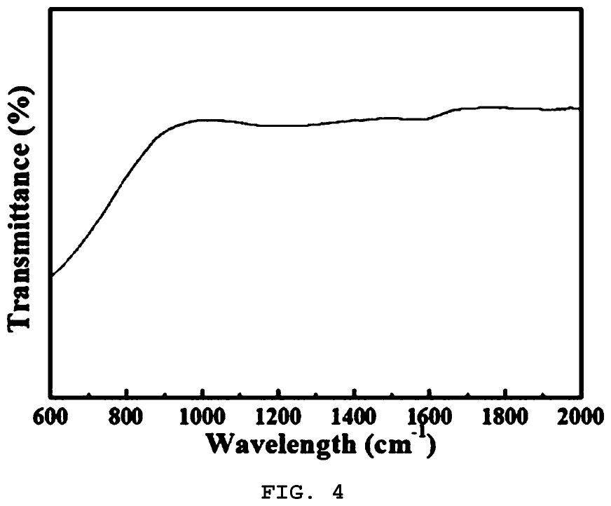

As a result of FT-IR analysis of the black titanium dioxide powder prepared in Example 1, the peak observed between 1200 cm⁻¹ and 1500 cm⁻¹ is shown by the CO bond and the CH bond of the methyl group, showing that methyl group was formed on the surface of the nanoparticles (FIG. 4).

### Experimental Example 4—Reflectance

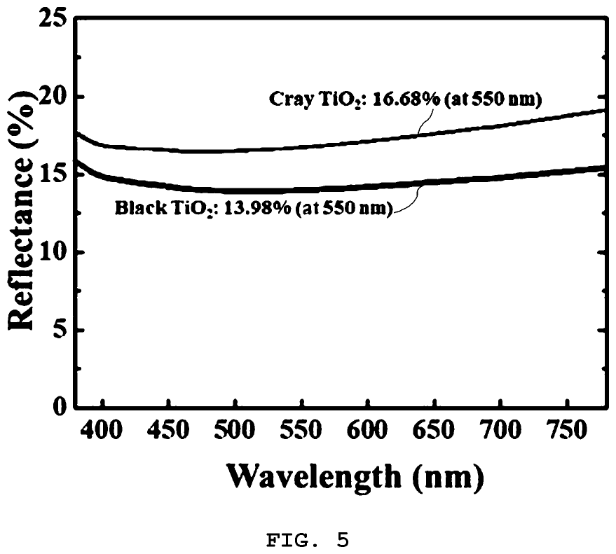

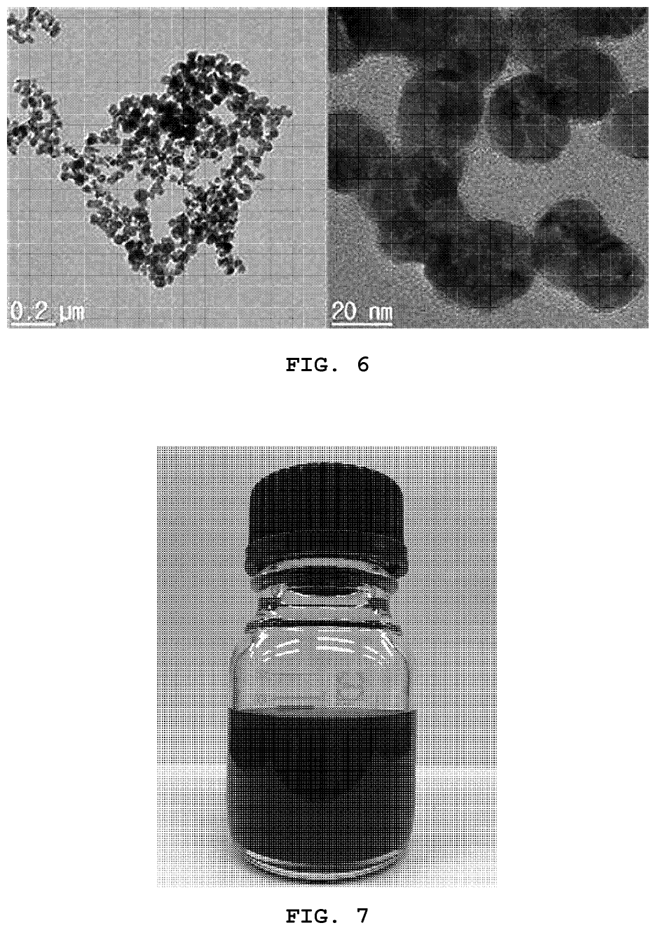

The reflectance of the black titanium dioxide (TiO₂₋ₓ) nanoparticle powder prepared by the preparing method of Example 1 was confirmed to be 13.98% as a result of measurement using an ultraviolet-visible light spectrometer. The reflectance of the gray titanium dioxide (TiO₂₋ₓ) nanoparticle powder prepared by the preparing method of Comparative Example 1 was confirmed to be 16.68% as a result of measurement using an ultraviolet-visible light spectrometer. Through these results, it was found that the black titanium dioxide prepared in Example 1 had excellent blackness (FIG. 5).

### Experimental Example 5—Particle Size

As a result of measuring the particle size of the black titanium dioxide (TiO₂₋ₓ) nanoparticle powder prepared by the preparing method of Example 1 through a transmission electron microscope, the primary particle size was in the range of 5 nm to 200 nm (FIG. 5).

### Experimental Example 6—Particle Size Analysis

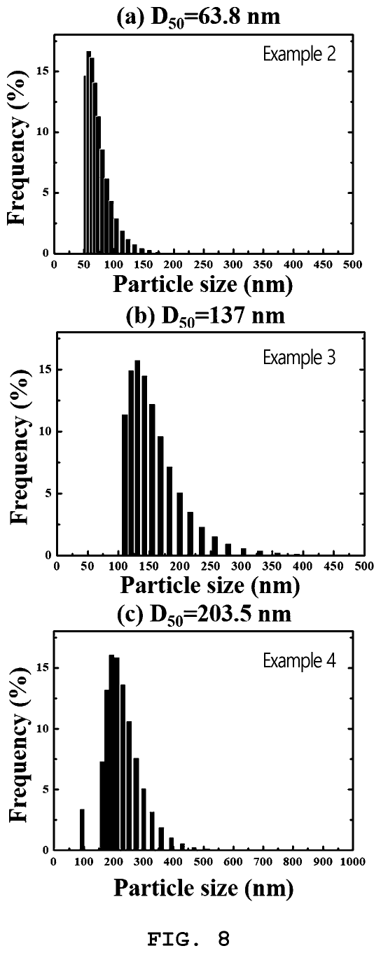

As a result of analyzing the average particle size of black titanium dioxide nanoparticles distributed in ink containing the black titanium dioxide (TiO₂₋ₓ) powder and the solvent prepared by the method of Example 2 using a nanoparticle size analyzer. It was confirmed to have an average particle size of 63.8 nm (FIG. 7(a)). In addition, the average particle size of black titanium dioxide nanoparticles distributed in each ink of the ink containing the black titanium dioxide (TiO₂₋ₓ) powder and solvent prepared by the methods of Examples 3 and 4 was analyzed using a nanoparticle size analyzer. It was confirmed to have an average particle size of 137 nm and 203.5 nm (FIGS. 8(b) and 8(c)).

### Experimental Example 7—Dispersibility of Black Titanium Dioxide (TiO₂₋ₓ) Powder

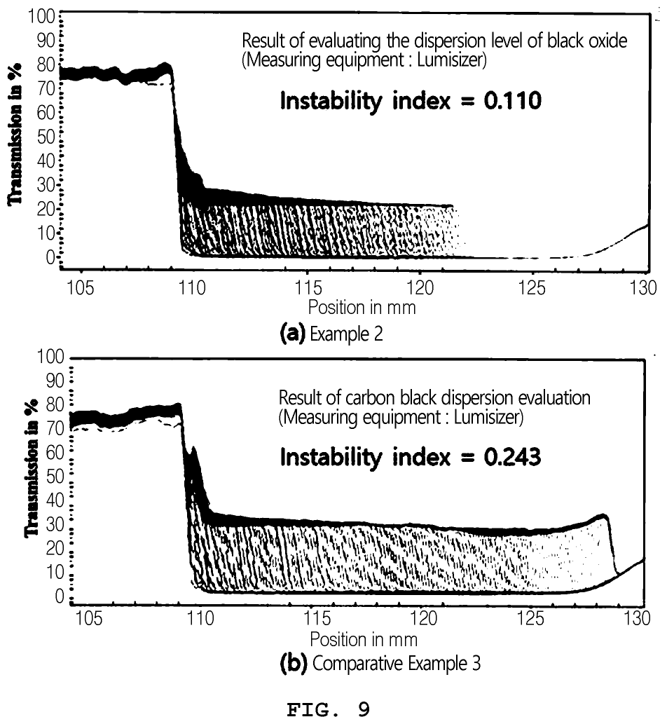

The dispersibility of the ink prepared in Example 2 and Comparative Example 3 was compared and analyzed using LUMiSizer equipment manufactured by LUM-Gmbh, Germany (measure the sedimentation and non-uniformity of the material using an optical sensor while accelerating the sedimentation/rise rate of the particles by applying centrifugal force to the ink). FIG. 9 is a graph obtained using LUMiSizer under the same test conditions for ink containing black titanium dioxide (TiO₂₋ₓ) and ink containing carbon-black, respectively. The dispersion stability index converted using the analysis result was 0.110 for ink containing black titanium dioxide (TiO₂₋ₓ) and 0.243 for ink containing carbon-black, indicating better dispersion stability when containing black titanium dioxide (TiO₂₋ₓ).

### Example 4—Black Titanium Dioxide (TiO₂₋ₓ) Based Electrophoretic Display Fabrication

A display for confirming the electrophoretic properties of the ink containing black titanium dioxide (TiO₂₋ₓ) powder and a solvent in Example 2 was manufactured. As the lower electrode, ITO Glass was patterned to form a plurality of line-shaped patterns with an ITO line width of 30 um and an interval between ITO patterns of 70 um. In addition, as the upper electrode, general ITO glass was used without a pattern. Parts of the edge were attached to maintain the gap with a double-sided tape having a thickness of 20 μm, and the ink prepared in Example 2 was injected into a gap between ITO glass plates for upper and lower electrodes using a dropper and then sealed.

### Experimental Example 8—Evaluation of Characteristics of Black Titanium Dioxide (TiO₂₋ₓ)-Based Electrophoretic Display

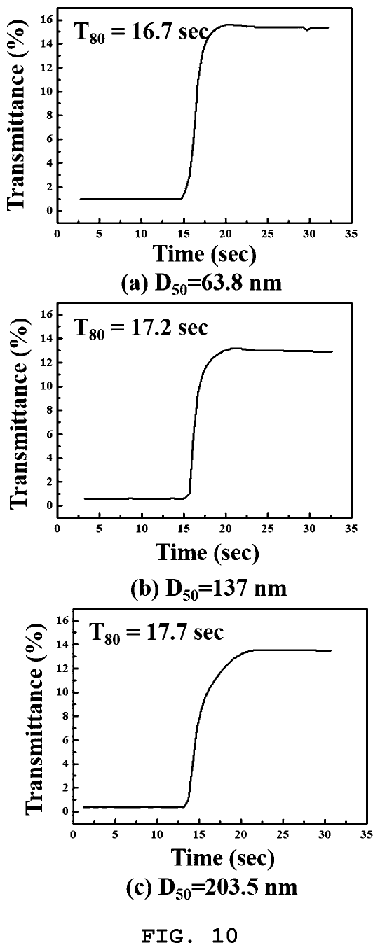

In order to evaluate the driving characteristics of the ink in the black titanium dioxide (TiO₂₋ₓ)-based electrophoretic display prepared in Example 4, a voltage of DC V is applied to the upper and lower electrodes of the display using a power supply. After application, the change in transmittance with time was measured in real-time with a time interval of 2 seconds through a UV-Spectrometer. As a result, shown in FIG. 10, it can be confirmed that the smaller the size of the nanoparticles of black titanium dioxide (TiO₂₋ₓ), the faster the reaction rate.

As described above, it will be apparent to those skilled in the art that such a specific technique is merely a preferred embodiment, and thus the scope of the present disclosure is not limited thereto. Accordingly, it is intended that the substantial scope of the present disclosure be defined by the appended claims and their equivalents.

1. A pigment for electrophoretic display, the pigment containing inorganic oxide.

2. The pigment of claim 1, wherein the inorganic oxide is black titanium dioxide (TiO₂₋ₓ).

3. The pigment of claim 2, wherein the black titanium dioxide has a crystal phase selected from the group consisting of anatase phase, rutile phase, and mixtures thereof.

4. The pigment of claim 1, wherein the pigment includes a core part made of the inorganic oxide and a shell part surrounding the surface of the core part.

5. The pigment of claim 4, wherein the shell part is hydrophobic.

6. The pigment of claim 4, wherein the shell part comprises any one among one or more hydrocarbons, phosphoric acid, and a combination thereof.

7. The pigment of claim 6, wherein the hydrocarbon is a methyl group.

8. The pigment of claim 1, wherein the pigment has a particle diameter of 5 nm to 200 nm.

9. The pigment of claim 1, wherein the pigment exhibits a reflectance of 14% or less for visible light.

10. An ink composition for an electrophoretic display, the ink composition comprising the pigment of claim 1, a dielectric medium in which the pigment particles are dispersed, and an additive for enhancing the dispersion properties of the pigment.

11. The composition of claim 10, wherein the dielectric medium has a dielectric constant of 2 to 10 F/m.

12. An electrophoretic display comprising the ink composition of claim 10.

13. An electrophoretic display comprising the ink composition of claim 11.
